(19) United States
(12) Patent Application Publication
(10) Pub. No.: US 2011/0033055 A1
(43) Pub. Date: Feb. 10, 2011

(54) Voice Communication Device, Signal Processing Device and Hearing Protection Device Incorporating Same

(75) Inventors: Siow Yong Low, Cannington (AU); Erik Niklas Ostlin, Hamilton Hill (AU); Alan Davis, Riverton (AU)

Correspondence Address: MCANDREWS HELD & MALLOY, LTD, 500 WEST MADISON STREET, SUITE 3400, CHICAGO, IL, 60661, US

(73) Assignee: SENSEAR PTY LTD., Nedlands, WA (AU)

(21) Appl. No.: 12/673,088

(22) PCT Filed: Sep. 5, 2008
(86) PCT No.: PCT/AU2008/001323

§ 371 Date: Oct. 21, 2010

(30) Foreign Application Priority Data
Sep. 5, 2007 (AU) 2007904819
Sep. 5, 2007 (AU) 2007904820
Oct. 16, 2007 (AU) 2007905682

(51) Int. Cl. H04R 29/00

(52) U.S. Cl. 381/56

(57) ABSTRACT

Signal processing device comprising: a signal analyser (7) for analysing a received signal into the subband domain; a first signal path (10) and a second signal path (11), the first signal path (10) being decoupled from the second signal path (11), whereby the first signal path (10) and the second signal path (11) are arranged to pass the received signal; only the first signal path (10) includes automatic gain control (3), the first signal path (10) further includes one or more speech metric functions (4, 5, 6) to determine estimated gain functions therein, the signal in the first signal path being passed from the automatic gain control (3) to the one or more speech metric functions (4, 5, 6) to enable determination of the estimated gain functions, the estimated gain functions determined by the one or more speech metric functions being combined to generate an overall gain function which is applied (9) to the signal (14) in the second signal path (11) to generate an enhanced signal; and a signal synthesiser (8) for synthesising the enhanced signal (12) into a fullband representation.

### FIELD OF THE INVENTION

Throughout the specification unless the context requires otherwise, the word “comprise” or variations such as “comprises” or “comprising”, will be understood to imply the inclusion of a stated integer or group of integers but not the exclusion of any other integer or group of integers.

Throughout the specification unless the context requires otherwise, the word “include” or variations such as “includes” or “including”, will be understood to imply the inclusion of a stated integer or group of integers but not the exclusion of any other integer or group of integers.

The present invention relates to a voice communication device, a signal processing device and a hearing protection device incorporating same.

### BACKGROUND ART

The following discussion of the background art is intended to facilitate an understanding of the present invention only. The discussion is not an acknowledgement or admission that any of the material referred to is or was part of the common general knowledge as at the priority date of the application.

A hearing protection device is often embodied as an ear muff, which is a device or apparatus that, when in an operative state, sits adjacent to a user's ear and blocks external sound from reaching the ear of the user.

Current sound attenuation and enhancement ear muffs work by enclosing all electronics within the ear cups of the earmuffs. In order to enable a user to be in audio communication with other people, the earmuffs include one or more microphones enclosed within the earmuff which can detect external sounds which are then processed and delivered to the wearer through a loudspeaker also enclosed within the earmuff and adjacent the wearer's ears.

Often hearing protection devices need to use fixed point processors in order to keep power usage low. These hearing protection devices thus can suffer from precision losses due to the need to use fixed point processors. Conventionally, automatic gain control (AGC) is used to provide an appropriate dynamic range for fixed point processing, however this can lead to ‘pumping effects’ at the output signal. Pumping effects may cause the characteristics of the background noise to be distorted which is both annoying and a safety concern to the wearer.

One method used to mitigate the pumping effects due to the AGC is to “descale” the scaling imposed by the AGC. This means that the overall output is multiplied with the inverse of the AGC gain (which has been applied to the input). However, in most signal processing algorithms, the relationship between the input and output is not a simple mapping and thus descaling may not entirely remove the effects of AGC.

### DISCLOSURE OF THE INVENTION

According to one aspect of the present invention, there is provided a signal processing device comprising: a signal analyser for transforming a received signal into the subband domain; a first signal path and a second signal path, the first signal path being decoupled from the second signal path, whereby the first signal path and the second signal path are arranged to pass the received signal; only the first signal path includes automatic gain control, the first signal path further includes one or more signal processing means to determine filters therein, the signal in the first signal path being passed from the automatic gain control to the one or more signal processing means to enable determination of filters, the filters determined by the one or more signal processing means being combined to generate one or more overall filters which are applied to the signal in the second signal path to generate a processed signal; and a signal synthesiser for synthesising the processed signal into a fullband representation.

According to another aspect of the present invention, there is provided a voice communication device comprising a microphone, a loudspeaker and internal circuitry coupled to the microphone and loudspeaker, whereby the microphone is arranged to detect external sound, and to generate a signal in response to the detected sound, for forwarding to the internal circuitry, the internal circuitry includes a signal processor for processing the received signal, the processed signal being transmitted to the loudspeaker for conversion to an audio signal that can be heard by the wearer; wherein the signal processor comprises: a signal analyser for transforming a received signal into the subband domain; a first signal path and a second signal path, the first signal path being decoupled from the second signal path, the first and second signal paths being arranged to receive the received signal; only the first signal path includes automatic gain control; the first signal path further includes one or more signal processing means to determine filters therein, the signal in the first signal path being passed from the automatic gain control to the one or more signal processing means to enable determination of the filters, the filters determined by the one or more signal processing means being combined to generate one or more overall filters which are applied to the signal in the second signal path to generate a processed signal; and a signal synthesiser for synthesising the processed signal into a fullband representation.

According to a third aspect of the present invention, there is provided a method for processing signals, the method comprising: transforming a received signal into the subband domain; passing the received signal into a first signal path and a second signal path, the first signal path being decoupled from the second signal path; applying automatic gain control to the signal in the first signal path only; determining filters in one or more signal processing means in the first signal path, combining the filters to generate one or more overall filters which are applied to the signal in the second signal path to generate a processed signal; and synthesising the processed signal into a fullband representation.

According to a fourth aspect of the present invention, there is provided a hearing protection device including a voice communication device comprising a microphone, a loudspeaker and internal circuitry coupled to the microphone and loudspeaker, whereby the microphone is arranged to detect external sound, and to generate a signal in response to the detected sound, for forwarding to the internal circuitry, the internal circuitry includes a signal processor for processing the received signal, the processed signal being transmitted to the loudspeaker for conversion to an audio signal that can be heard by the wearer; wherein the signal processor comprises: a signal analyser for transforming a received signal into the subband domain; a first signal path and a second signal path, the first signal path being decoupled from the second signal path, the first and second signal paths being arranged to receive the received signal; only the first signal path includes automatic gain control; the first signal path further includes one or more signal processing means to determine filters therein, the signal in the first signal path being passed from the automatic gain control to the one or more signal processing means to enable determination of the filters; the filters determined by the one or more signal processing means being combined to generate one or more overall filters which are applied to the signal in the second signal path to generate a processed signal; and a signal synthesiser for reconstructing the processed signal into a fullband representation.

Preferably, the filters are determined on the basis of ratios.

Preferably, the filters have only one coefficient per subband.

Preferably, the filters are represented with fixed point representation.

Preferably, the overall filters consist of a set of filters, whereby there is one overall filter per subband.

Preferably, filters generated by the one or more signal processing means are invariant to the AGC gain.

Preferably, the one or more signal processing means adapt the filters based on the received signal.

Preferably, the one or more signal processing means comprises a speech enhancement and noise suppression function.

Preferably, one or more of the signal processing means generates filters to suppress tonal noise.

Preferably, one or more of the signal processing means generates filters to suppress impulsive noise

Preferably, one or more of the signal processing means generates filters to enhance speech.

Preferably, one or more of the signal processing means enhances speech and includes a voice activity detector (VAD).

Preferably, the hearing protector is an earmuff or earplug.

Preferably, the hearing protector provides hearing protection by sound suppression substantially in the range from 15 dB to 50 dB.

Preferably, the one or more signal processing means comprise one or more signal processing algorithms.

Preferably, the signal processing algorithms are implemented in fixed point.

Preferably, the end-to-end delay of the signal processor is less than 16 ms.

Preferably, the first signal path has a numerical precision representation that is different from the numerical precision representation of the second signal path.

Preferably, the first signal path has a numerical precision representation that is lower than the numerical precision representation of the second signal path.

Preferably, the signal analyser is an analysis filterbank.

Preferably, the signal synthesiser is a synthesis filterbank.

Preferably, the signal processor is optimised for digital fixed point signal processing tasks.

### BRIEF DESCRIPTION OF THE DRAWINGS

The invention will now be described, by way of example only, with reference to the accompanying drawings, in which:

FIG. 1a is a schematic representation of the components of an embodiment of a hearing protection device in accordance with an aspect of the present invention;

FIG. 1b is a schematic representation of the functional components of an embodiment of the internal circuitry of the hearing protection device illustrated in FIG. 1a;

FIG. 2 is a schematic representation of the functional components of an embodiment of the signal processing function in accordance with another aspect of the present invention;

FIG. 3 is an illustration of a speech signal corrupted by impulsive noise;

FIG. 4 illustrates the mean value of the instantaneous estimate of the envelope of the signal of FIG. 3 across the subband;

FIG. 5 is a schematic representation of the functional components of an embodiment of the TINS signal processing function described herein;

FIGS. 6a and 6b are a schematic diagrams showing the signal processing chain of separate embodiments of the noise excursion attenuation device and method described herein;

FIG. 7 is a flowchart of an embodiment of the signal processing performed by the noise excursion attenuation processor shown in FIG. 7;

FIG. 8 is a graph showing an example of an average power spectrum, a 0^{th} order polynomial fit, and the threshold using the noise excursion attenuation device shown in FIGS. 6 and 7;

FIG. 9 is a graph showing an example of the resulting spectrum, using the noise excursion attenuation device shown in FIGS. 6 and 7, and the threshold resulting from the 0th order polynomial fit;

FIG. 10 is a graph showing an example of an average power spectrum, the 1st order polynomial fit, and the threshold using the noise excursion attenuation device shown in FIGS. 6 and 7;

FIG. 11 is a graph showing an example of the resulting spectrum and the threshold originating from the 1st order polynomial fit using the noise excursion attenuation device shown in FIGS. 6 and 7;

FIG. 12 is a graph showing an example of the gain function γₖ(n) [dB] over time (spectrogram) using the noise excursion attenuation device shown in FIGS. 6 and 7;

FIG. 13 is an example of a two dimensional graph of time v frequency showing the effect of the noise excursion attenuation device shown in FIGS. 6 and 7; and

FIG. 14 is an example of a three dimensional graph of time v frequency v power showing the effect of the noise excursion attenuation device shown in FIGS. 6 and 7.

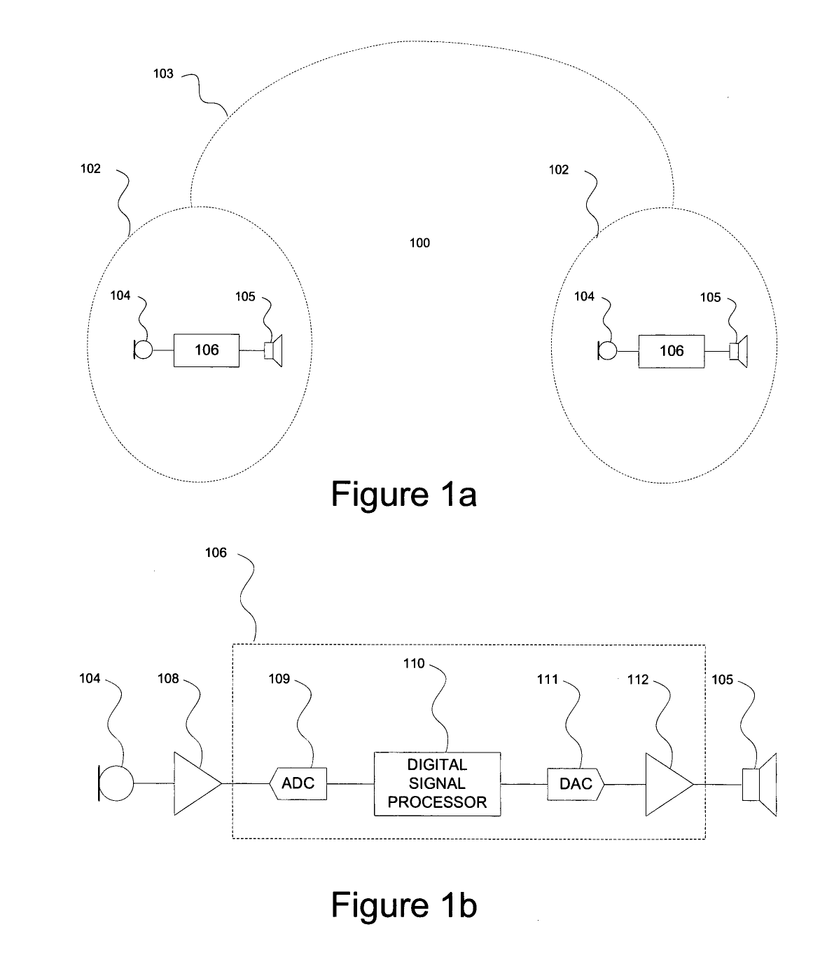

### BEST MODE(S) FOR CARRYING OUT THE INVENTION

A hearing protection device 100 comprises two ear muffs 102 (in the form of ear cups) that are connected by a headband 103 and designed to be worn over a wearer's head with the two ear muffs 102 covering the wearer's ears. The ear muffs 102 house internal circuitry 106, one or more microphones 104 and one or more loudspeakers 105 coupled to the internal circuitry to perform the invention as will be described in further detail herein.

The microphones 104 are located within the ear muffs 102. The microphones 104 are arranged to pick up external sound, and to generate a signal for forwarding to the internal circuitry 106 in response to the sound. The internal circuitry 106 is operable to process the received signal, and then deliver the processed signal to the loudspeakers 105. The processed signal is then converted to an audio signal that can be heard by the wearer at the loudspeakers 105.

In this embodiment the internal circuitry 106 comprises an amplifier 108 which amplifies the signal generated by the microphone 104 to create an amplified signal. The amplifier 108 is coupled to an analogue to digital convertor 109 which converts the amplified signal generated by the amplifier 108 to a digital received signal. The analogue to digital convertor 109 is coupled to the digital signal processor 110 which provides signal processing functionality and generates a digital processed signal in response to the digital received signal. The digital signal processor 110 also coupled to the digital to analogue convertor 111 which receives the digital processed signal and generates a corresponding analogue processed signal in response to the digital processed signal. The digital to analogue convertor 111 is coupled to an amplifier 112 which generates an amplified analogue processed signal in response to the analogue processed signal. The amplifier 112 is coupled to the loudspeaker 105 which generates an audio signal that can be heard by the wearer in response to the applied amplified analogue processed signal generated by the amplifier 112.

The present invention provides a signal processing technique where automatic gain control (AGC) is used only to control the dynamic range of the received signal coupled to the signal processing algorithms collectively 15, thereby decoupling it from the actual signal output path. This is implemented within the digital signal processor 110 that provides signal processing using digital signal processing techniques.

In addition, the signal processing functions 15 generate filters which when applied to the received subband signal in the lower path 11 provide noise suppression, impulsive noise suppression, tonal disturbance suppression and speech enhancement in the sound heard in the hearing protection device 100. Here, suppression refers to the suppression of undesired disturbances to a desired level, whilst allowing voice communication at the same time. Also, the algorithm maintains the timbre of the suppressed undesired disturbances such that the wearer is still aware of the types of disturbances.

The invention is a two path structure for signal processing, which provides automatic gain control in one path along with signal processing algorithms. This allows different precision representation levels in its two independent signal paths, whereby in this embodiment a low numerical precision representation is employed in the upper path and a high numerical precision representation is employed in the lower path. This means that the upper path has more quantisation noise and reduced dynamic range when compared to the lower path.

A low numerical precision representation will typically require aggressive automatic gain control. In a traditional single path structure where the AGC is present in the output signal path noise pumping effects may be present whereby low amplitude signals are amplified and high amplitude signals are attenuated by the AGC. This is both annoying for the wearer of a device and distorts the perception of the wearer of their environment.

Incorporating the AGC within the two path structure described means that an aggressive AGC can be employed to condition the signal in the upper path to the available dynamic range. This conditioning is performed to make the signal suitable for processing by the signal processing algorithms. In the case that the output from the signal processing algorithms is invariant to the AGC, the output when applied in the lower path to the signal will thus not by influenced by the AGC and will thus not be heard by the wearer. A significant consequence of the two path structure is that a lower precision numerical representation may be employed in the upper path whilst maintaining a high precision numerical representation in the lower path. The result of this is that the fidelity of the original signal is maintained, yet computational savings can be achieved due to the reduced precision numerical representation in the upper path.

Here, the upper signal path 10 consists of a low precision numerical representation to ease computational burden in the computation by the signal processing algorithms. The lower signal path 11, on the other hand, consists of a high precision numerical representation to ensure a good representation of the overall output signal and high fidelity.

In the embodiment described herein, the invention comprises two signal paths with different precision numerical representation levels. The upper signal path comprises the AGC 3 and the relevant speech processing algorithms 15, which in this case are spectral subtraction (SS) 4, transient and impulsive noise suppressor (TINS) 5 and noise excursion attenuation device (NEAD) 6. Because of its lower precision numerical representation in the upper signal path, the role of the AGC 3 is to provide a proper scaling of the numbers such that good numerical accuracy can still be achieved in the computation carried out by the signal processing blocks collectively 15. Owing to the fact that all the signal processing algorithms 15 are AGC invariant by way of their ratio based approach, all the scaling due to AGC 3 is automatically removed and thus not heard by the user. Each of the signal processing algorithm blocks estimate filters, which are combined together in this embodiment to give one overall filter per subband. These overall filters are then applied to the signal in the lower signal path to give a processed signal. The signal in the lower signal path is void of the AGC 3. A brief explanation of each signal processing function is as follows:

SS 4—This is used for noise suppression. A voice activity detector (VAD) 2 may be employed to identify speech silent periods and to estimate the noise statistics. A filter is then formed to suppress the background noise.

TINS 5—This is used for impulsive noise suppression. The TINS signal processing algorithm relies on a long-term and a short-term average of the observed signal to form a ratio such that the impulsive noise can be detected and suppressed simultaneously.

NEAD 6—This is used for tonal disturbance suppression. The NEAD algorithm estimates a regression line from the observed signal. From the regression line, any tonal disturbance is detected and suppressed accordingly.

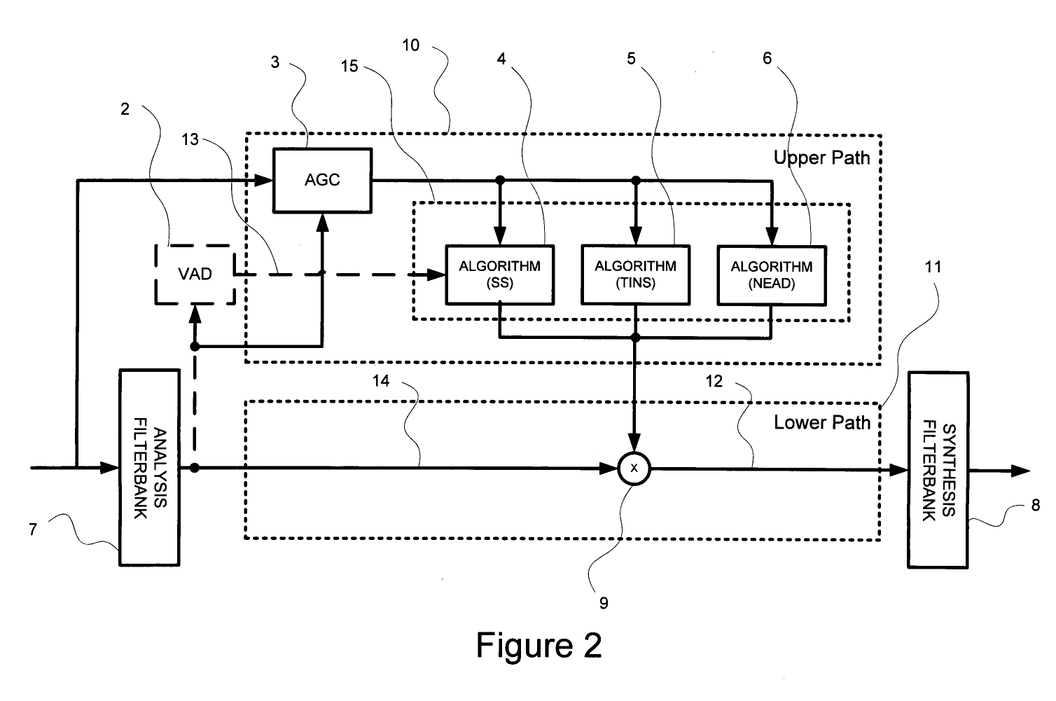

The signal processing functionality is illustrated schematically using the block diagram of FIG. 2.

The embodiment described here is based upon the previously described two path structure in the frequency domain, comprising an upper path 10, and a lower path 11. The upper path 10 consists of three signal processing algorithms—namely SS 4, TINS 5 and NEAD 6. These three signal processing algorithms are designed to generate filters on the basis of a signal represented in a low precision fixed point format. The resultant filters are then combined and applied to the signal represented in a high precision fixed point format in the lower path 11 to produce the overall output. Because the signal processing algorithms SS 4 and TINS 5 are based on the use of ratios, the resultant filters are functions of ratio of input signals. As such, the filters are not susceptible to the AGC, i.e. they are AGC invariant. This is because any scaling imposed by the AGC will cancel out when calculating the ratio. Likewise, the NEAD 6 signal processing algorithms resultant filter is generated as a function of relative ratio of the peak(s) and an estimated regression line. Thus, the two path structure provides a good precision range for fixed point implementation and at the same time allows a seamless speech processing scheme. For that reason, and as mentioned above, this invention could equally be applied to any signal processing technique using ratio determinations or any other signal processing technique that generates outputs that are invariant to AGC gain. FIG. 2 illustrates the signal processing technique described herein. As described above, the invention comprises a two path structure comprising an upper path 10 and a lower path 11.

A more detailed description follows:

A signal from one or more microphones 104 is input to the signal processing block diagram illustrated schematically in FIG. 2. The incoming audio signal is transformed into subband domain by the analysis filterbank 7. At that stage, the signal is split into two paths: the upper path 10 and the lower path 11.

The upper path 10 shown in FIG. 2 is responsible for the gains estimation of the SS 4, TINS 5 and the NEAD 6 algorithms. Note that the subband inputs to the three algorithms 4, 5, 6 are gain controlled by the AGC 3 to ensure a good signal representation range.

A voice activation device (VAD) 2 may be used to detect when the incoming signal represents speech. In this embodiment, in the case where a VAD 2 is used, only the SS algorithm 4 requires speech active and inactive information 13 from the VAD 2. Strictly speaking, the VAD information is not limited to SS 4 but may also be used in the NEAD algorithm 6. For instance, the adaptation in the NEAD algorithm can be limited to non-speech periods only. This may prevent cancellation of dominant tones present in speech signals.

In this embodiment, a feed forward AGC 3 is employed to provide a good precision range in the upper path 10. The gain applied by the AGC 3 can be determined from well known techniques in the art. Once the gain is applied to the incoming subband signal generated by the analysis filterbank, the signal processing algorithms 15 estimate filters.

In the lower path 11, the estimated filters from the SS 4, TINS 5 and NEAD 6 algorithms are applied, as signified by reference numeral 9, to the incoming subband signals 14. Because in this embodiment there is only a single tap for each subband filter, the overall filter can be written as

G_{OVERALL}(m,k)=G_{SS}(m,k)·G_{TINS}(m,k)·G_{NEAD}(m,k). (0.3)

where G_{SS}(m,k), G_{TINS}(m,k) and G_{NEAD}(m,k) are the filters from the SS, TINS and NEAD algorithms at the k-th spectral components of the short-time frame, m, respectively. The overall processed subband output signal 12 is given as

Y(m,k)=X(m,k)·G_{OVERALL}(m,k). (0.4)

where X(m,k) is the k-th subband signal of the lower signal path at the m-th time frame.

Following that, the subband signals Y(m,k) are then reconstructed into fullband representation by a synthesis filterbank 8.

There follows a more detailed description of the SS, TINS and NEAD algorithms 4, 5, 6.

For ease of exposition, the following noisy speech signal model is adopted:

$$x ( n ) = {\underbrace{s ( n )}}_{speech} + {\underbrace{v ( n )}}_{background noise} + {\underbrace{i ( n )}}_{impulsive noise} + {\underbrace{t ( n )}}_{tonal noise} \qquad ( 0.5 )$$

where s(n), v(n), i(n) and t(n) are the speech signal, background noise signal, impulsive noise and tonal noise, respectively. Here, SS is designed to suppress v(n), TINS is designed to suppress i(n) and finally NEAD is designed to suppress with t(n). Since the three algorithms are designed to work in parallel, the following description of the algorithm will adopt the signal model under the presence of the corresponding type of noise it is dealing with. For instance, SS will adopt a signal model where the observed signal consists of s(n) and v(n), likewise both TINS and NEAD will adopt a signal model consists of s(n) and i(n) & s(n) and t(n), respectively.

### Spectral Subtraction

A typical additive noise model for the noisy speech signal can be written as

x(n)=s(n)+v(n) (0.6)

where s(n) and v(n) are the speech signal and noise signal, respectively. The k-th spectral component of the short-time frame, m of equation (0.6) can be expressed as

X(m,k)=S(m,k)+V(m,k). (0.7)

The aim is to minimize the noise contribution, V(m,k), whilst preserving the speech contribution, S(m,k). This can be performed by applying a filter, G_{SS}(m,k) to estimate the speech spectrum as

Y_{SS}(m,k)=G_{SS}(m,k)·X(m,k). (0.8)

The filter G_{SS}(m,k) may be determined by well known techniques in the art.

### Transient and Impulsive Noise Suppressor (TINS)

A transient and impulsive noise suppressor aims to reduce the impact or the annoyance of transient and impulsive noise. Examples of transient and impulsive noise include gun shots, loud bangs, door slamming and hammering. A transient and impulsive noise suppressor is used to protect hearing while operating in dangerous impulsive noise environments; it also allows the user to communicate while maintaining the characteristics of residual impulsive noise i.e. there is no distortion. It is also possible to hear warning signals etc. without distorting the characteristics of the suppressed noise.

Transient and impulsive noise suppressor techniques are well known in the art.

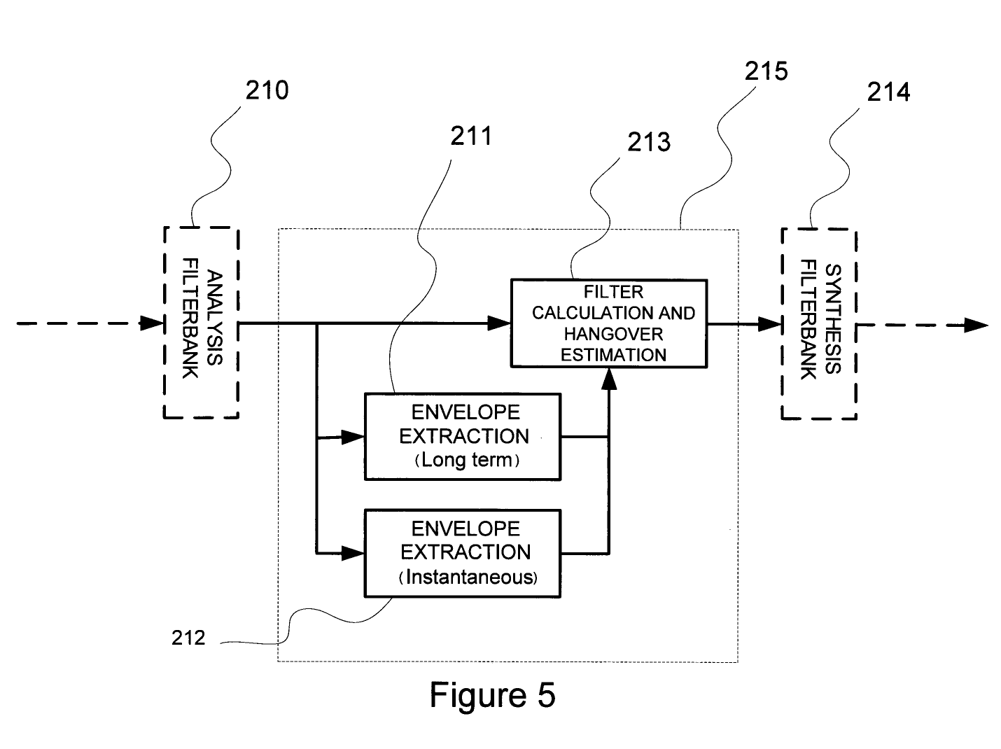

The following description relates to a specific embodiment of a transient and impulsive noise suppressor (TINS). However, the present invention described herein is not limited to the use of the specific embodiment of the transient and impulsive noise suppressor (TINS) described herein. Note that in the current embodiment, the input signal i.e. the received signal for the transient and impulsive noise suppressor (TINS) algorithm is readily analysed by the analysis filterbank 7 into the subband domain as shown in FIG. 2. However as a separate embodiment, the transient and impulsive noise suppressor (TINS) algorithm may stand alone and may have its own analysis filterbank 210 and synthesis filterbank 214 to analyse and synthesise the signals as shown in FIG. 5.

### EMBODIMENT

### Transient and Impulsive Noise Suppressor (TINS)

The transient and impulsive noise suppressor may be embodied in a signal processing device comprising: a signal analyser for analysing a received signal into subbands; a signal processing means for calculating a filter for each subband, the signal processing means being a ratio between the long term estimate of the received signal envelope and the instantaneous signal envelope of the received signal; a filtering process for applying the calculated filter on the received signal; and a signal synthesiser for synthesising the attenuated signal into a fullband processed representation.

Further, the transient and impulsive noise suppressor may be embodied in a method for processing signals, the method comprising: analysing the signal into the subband domain; calculating a filter from a signal processing means, the signal processing means being a ratio between the long term estimate of the received signal envelope and the instantaneous signal envelope of the received signal; filtering the received signal on the basis of the calculated signal processing function; and synthesising the suppressed signal into a fullband processed representation.

Further, the transient and impulsive noise suppressor may be embodied in a voice communication device comprising: a microphone, a loudspeaker and internal circuitry coupled to the microphone and loudspeaker; whereby the microphone is arranged to detect external sound, and to generate a signal in response to the detected sound, for forwarding to the internal circuitry, the internal circuitry includes a signal processor for processing the received signal, the processed signal being transmitted to the loudspeaker for conversion to an audio signal that can be heard by the wearer; wherein the signal processor comprises:
a signal analyser for analysing the signal received from the microphone into subbands; a signal processing means for calculating a filter for each subband, the signal processing means being a ratio between the long term estimate of the received signal envelope and the instantaneous estimate of the received signal envelope; a filtering process for applying the calculated filter on the received signal; and a signal synthesiser for synthesising the suppressed signal into a fullband processed representation which is then coupled to the loudspeaker.

Further, the transient and impulsive noise suppressor may be embodied in a hearing protection device that includes a voice communication device comprising: a microphone, a loudspeaker and internal circuitry coupled to the microphone and loudspeaker; whereby the microphone is arranged to detect external sound, and to generate a signal in response to the detected sound, for forwarding to the internal circuitry, the internal circuitry includes a signal processor for processing the received signal, the processed signal being transmitted to the loudspeaker for conversion to an audio signal that can be heard by the wearer; wherein the signal processor comprises:
a signal analyser for analysing the signal received from the microphone into subbands; a signal processing means for calculating a filter for each subband, the filter is calculated as a ratio between the long term estimate of the received signal envelope and the instantaneous estimate of the received signal envelope; a filtering process for applying the calculated filter on the received signal; and a signal synthesiser for synthesising the suppressed signal into a fullband processed representation which is then coupled to the loudspeaker.

The overall calculated filter may be an average of the filter in each subband.

The signal processing means may be operable to determine a predetermined period through which the filter is applied on the received signal.

The filter may be an one tap filter and as such the signal processing means may be operable to determine whether the filter is above or below a predetermined threshold, in which case the signal is suppressed for the length of the predetermined period if the filter is below the predetermined threshold.

The signal processing means may comprise a signal processing algorithm.

If the filter is above the predetermined threshold, then the instantaneous estimate of the signal envelope is reduced by a predetermined amount.

FIG. 5 is functional block diagram illustrating the functional components of the TINS signal processing described herein.

As a preamble to the further description of the TINS signal processing described herein, a typical additive noise model for a noisy speech signal with impulsive noise can be written in the subband domain as

X(m,k)=S(m,k)+I(m,k). (0.12)

where S(m,k) and I(m,k) are the speech and impulsive components at the k-th subband and m-th frame.

The aim is to suppress the impulsive noise contribution, I(m,k) whilst preserving the speech contribution, S(m,k) to thereby improve the performance of a hearing protection device 100. Impulsive noise is transient in nature. Typically, impulsive noise consists of a series of bursts of sound energy, each burst having duration of approximately 10 ms-30 ms.

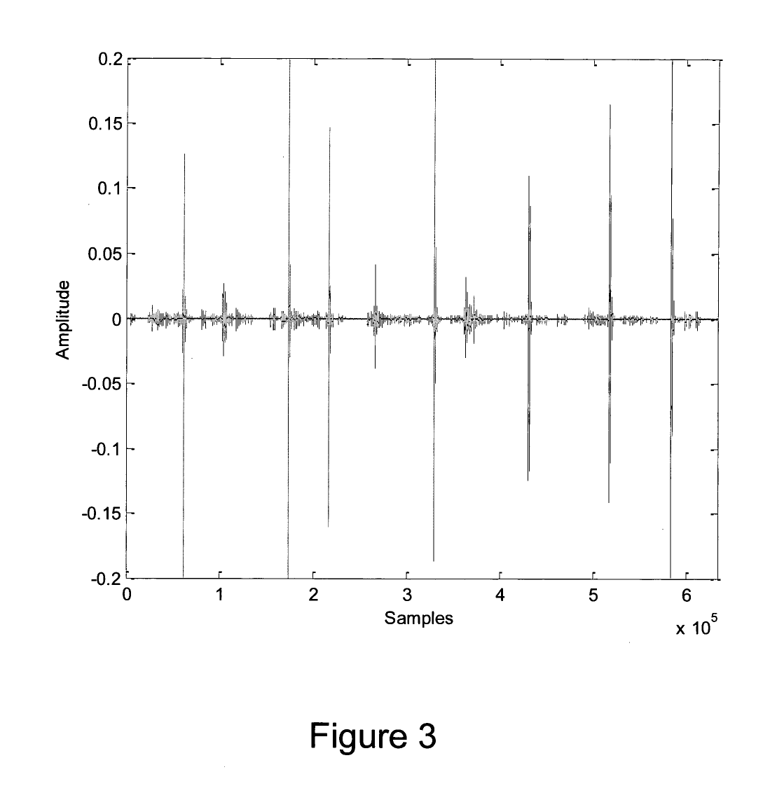

FIG. 3 shows a plot of a speech signal corrupted by impulsive noise. From FIG. 3, it can be observed that impulsive noise exhibits one or more high peak(s)/spike(s) of short duration (transient).

The TINS algorithm described herein is based on the observation that impulsive noise is “bursty” in nature and exhibits large spikes in the signal, i.e.,

|I(m,k)|>>|S(m,k)| (0.13)

where |·| denotes the absolute value operator. As such, the instantaneous estimate of the signal envelope can be used to detect the presence of impulsive noise as

|Xᵢₘₚᵤₗₛᵢᵥₑ(m,k)|>>|X(n,k)| (0.14)

where |Xᵢₘₚᵤₗₛᵢᵥₑ(m,k)| is the envelope of the signal when I(m,k)>0 and |X(m,k)| is the envelope of the signal when I(m,k)=0.

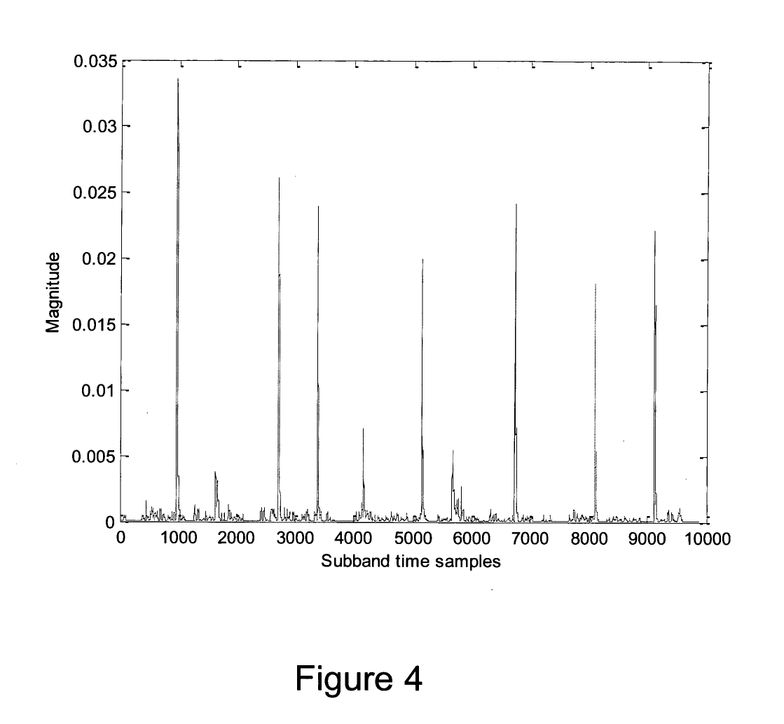

FIG. 4 shows the mean of the instantaneous estimate of envelope of all subbands of the signal in FIG. 3.

FIG. 5 is a simplified block diagram illustrating the functional components of the signal processing of the incoming audio signal on the basis of the TINS algorithm described herein. The signal processing involves dividing the incoming signal into different subbands via the analysis filterbank 210. Following that, the signal processing algorithm is used to calculate a filter for each subband. Both the long term signal envelope estimate 211 and the instantaneous signal envelope estimate 212 are used to calculate the filter in filter calculation 213. The filter is then applied to the subband signal to provide the appropriate impact noise suppression. Note that a hangover scheme 213 is also used to regulate the application of the filter on the subband signals. Here, the signal processing algorithm 215 detects the presence of impulsive noise and its eventual suppression. An overall filter 213 is calculated by averaging all the calculated filters in the subbands. In the current embodiment, the filter is then combined with the SS filter and NEAD filter via 9 in the lower path 11 as shown in FIG. 2. In general however, the TINS filter can be readily applied to the received signal and reconstructed via the synthesis filterbank 214 in FIG. 5.

Ideally, if there is no impulsive noise, the signal processing algorithm 215 should produce a filter, which passes the received signal unaltered.

Conversely, when there is impulsive noise, the signal processing algorithm 215 will have a filter, which will suppress the impulsive noise.

Assume a one tap filter, then the filter can be found by forming a ratio between the long-term estimate of the envelope signal and the instantaneous envelope estimate as the following function

$${G}_{TINS} ( m , k ) = \frac{{P}_{TINS , X} ( m , k )}{{P}_{TINS , X} ( m , k ) + {β}_{TINS} \vert X ( m , k ) \vert} . \qquad ( 0.15 )$$

The long-term envelope estimate, P_{TINS,X}(m,k) is estimated as

P_{TINS,X}(m,k)=α_{TINS}P_{TINS,X}(m−1,k)+(1−α_{TINS})|X(m,k) (0.16)

where the parameter, α_{TINS} is the long-term averaging constant. The parameter, β_{TINS} serves to regularize the value of the instantaneous envelope estimate, such that when there is no impulsive noise, the signal processing algorithm will maintain a filter which value is close to unity. This means that the filter will pass the signal unaltered when there is no impulsive noise.

In an effort to minimize variation in the filter, the resultant filter can be found by averaging the filters across all subbands.

From equation (0.15), it can be observed that under the presence of an impulsive noise, the instantaneous envelope estimate will be |X(m,k)|≧P_{X}(m,k). As a result, for a one-tap filter, the filter will be G_{TINS}(m,k) <<1. A threshold δ_{TINS} is introduced to ascertain the presence of impulsive noise and its subsequent suppression. As previously described herein, a typical impulsive noise lasts for approximately 10 ms-30 ms. However, due to its “bursty” nature, impulsive noise has a tendency to decay rapidly. Empirical observation suggests that typically only the first 10 ms of the envelope of an impulsive noise exhibits large values. Thus, there is a need to introduce a “hangover period” once an impulsive noise is detected. The purpose of the hangover period is to ensure that the impulsive noise is suppressed throughout its duration, i.e., its growth and decay part.

The hangover scheme 213 of the TINS algorithm will now be described. If the estimated filter is below the pre-determined threshold δ^{TINS}, then the filter will be calculated for the case when β_{TINS}=1. As such, the amount of impulsive noise is in proportion to its estimated values. The hangover scheme 213 will retain its value for a specified hangover period. If the calculated filter is above the threshold, then the instantaneous envelope 212 is set to be X % (β_{TINS}=X) of its value to avoid excessive suppression of the spectrum. Typically, a floor δ_{floor} is imposed to regulate the smallest gain function obtainable. Likewise, a ceiling is imposed on the filter to avoid excessive amplification.

Note that the TINS algorithm does not completely eliminate the impulsive noise but reduces the impulsive noise to a level similar to that of the speech signal. As such, one can view the TINS algorithm as preserving the dynamic range of the observed signal as well as maintaining the characteristics of the residual impulsive noise.

The TINS signal processing described herein may be implemented in a digital signal processor.

### Noise Excursion Attenuation Device (NEAD)

Noise excursion and attenuation techniques are well known in the art.

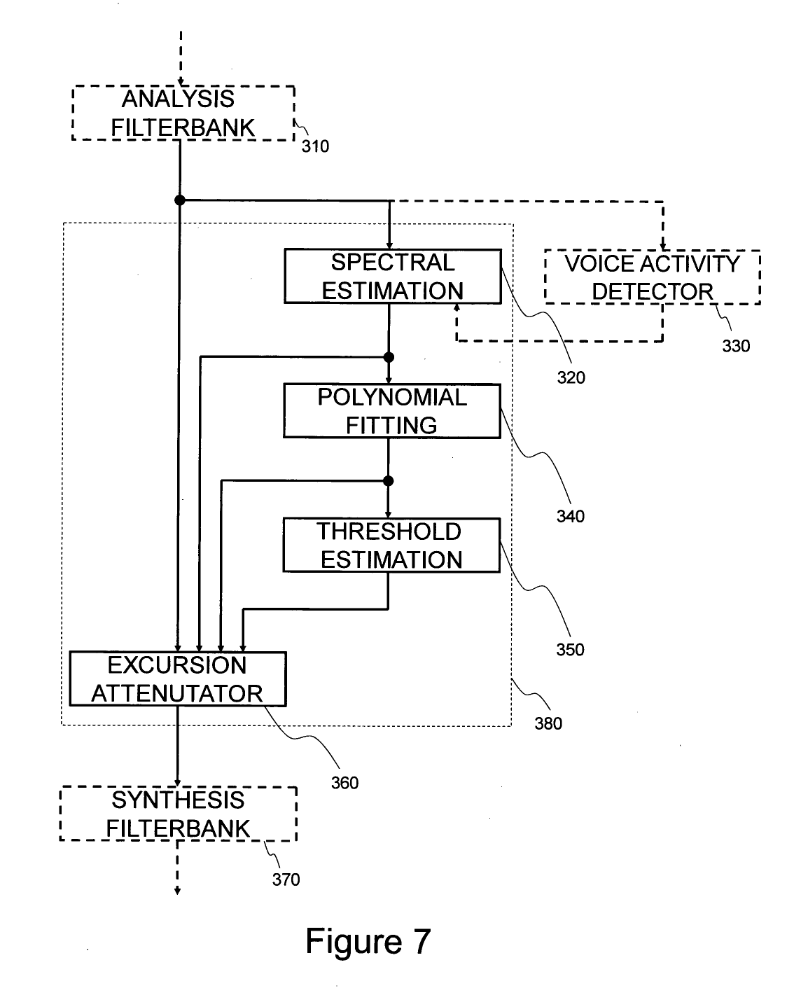

The following description relates to a specific embodiment of a noise excursion attenuation device, also referred to herein as NEAD. However, the present invention described herein is not limited to use of the specific embodiment of NEAD algorithm described herein. Note that in the current embodiment, the input signal i.e. the received signal for the NEAD algorithm is readily analysed by the signal analyser in the subband domain. However as a separate embodiment, the NEAD algorithm may stand alone and may have its own analysis filterbank 310 and synthesis filterbank 370 to analyse and synthesise the signals as shown in FIG. 7. In the following description, unless otherwise stated, the NEAD algorithm is assumed to be in the embodiment as illustrated in FIG. 7.

### Embodiment

### Noise Excursion Attenuation Device (NEAD)

The noise attenuation device comprises: spectral analysis means to receive a sound signal and to generate a spectral component signal in response to said sound signal; spectral estimation means to estimate the average power spectrum based on the spectral component signal, generated by said spectral analysis means, and generate an average power spectrum signal; mathematical modelling means to apply a mathematical equation to the average power spectrum; threshold estimation means to estimate a threshold and generate a threshold estimation signal based on said mathematical equation applied; attenuation means to determine the difference between the average power spectrum and the threshold estimation and attenuate the sound signals if the average power spectrum is greater than the estimated threshold.

In a situation where the sound signals received contain speech that is desired to be heard in a noisy environment, a voice activity detector means may also be provided. The spectral component signal is delivered to the voice activity detector means and upon detection of voice activity, the signals are delivered to the spectral estimation means.

As the voice activity detector means detects speech activity, no update of the average spectrum is performed by the spectral estimation means during non-speech activity.

The device may further comprise a sound reconstruction means to reconstruct the sound signal from its spectral components after attenuation by the attenuation means.

Further, a method for attenuating noise comprising: receiving a sound signal and generating a spectral component signal in response to said sound signal; estimating the average power spectrum based on said spectral component signal and generating an average power spectrum signal; applying a mathematical equation to the average power spectrum; estimating a threshold and generating a threshold estimation signal based on the mathematical equation applied; determining the difference between the average power spectrum and the threshold estimation; and attenuating the sound signal if the average power spectrum is greater than the estimated threshold.

In the case that the sound signal contains speech that is desired to be heard in a noisy environment, the method may further comprise detecting voice activity in said spectral component signal prior to estimating the average power spectrum.

The method may further comprise reconstructing the sound signal from its spectral components after attenuating the sound signal.

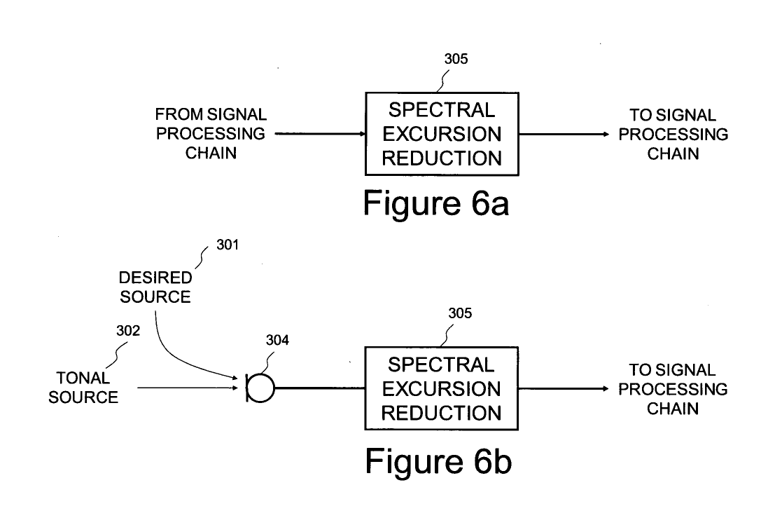

FIG. 6a illustrates a conceptual overview of the current embodiment of the noise excursion attenuation device 305 and FIG. 6b illustrates a different embodiment as a stand alone noise excursion attenuation device 305.

The noise attenuation device 305 is also referred to herein as the NEAD. In the current embodiment, the noise attenuation device 305 receives the analysed input signal data stream to produce the NEAD filter in the upper path 10 in FIG. 2. The filter along with the SS filter and the TINS filter, is then applied to the received signal in the lower path 11 via 9.

In a separate embodiment as shown in FIG. 6b, the NEAD may stand alone and the sound receiving sensor 304 may, for example, comprise a microphone system or an accelerometer, to pick up sound. The sound picked up or sensed by the sound receiving sensor 304 may contain information originating from a desired sound source 301 and tonal noise 302.

Assume that the received signal consists of only speech and tonal noise, the analysed received signal can be expressed as

X(m,k)=S(m,k)+T(m,k). (0.17)

where S(m,k) and T(m,k) are the speech and tonal components at the k-th subband and m-th frame, respectively.

The embodiment of the noise attenuation device 305 in FIG. 6b comprises an analysis filterbank 310, a synthesis filterbank 370 and the NEAD algorithm 380, which consists of a spectral estimator processor 320, a voice activity detector 330, a polynomial fitting processor 340, a threshold estimator 350 and an excursion attenuator processor 360.

The analysis filterbank 310 generates a spectral component signal representing the spectral components X(m,k).

The spectral estimator processor 320 receives the spectral component signal from the spectral analysis processor 310 and estimates the average power spectrum P_{NEAD}(m,k) based on the spectral components X(m,k). The spectral estimator processor 320 generates an average spectral component signal representing the average power spectrum P_{NEAD}(m,k).

The polynomial fitting processor 340 receives the average spectral component signal from the spectral estimator processor 320 and applies a polynomial equation R_{NEAD}(m,k) to fit the average spectral components P_{NEAD}(m,k). The polynomial fitting processor 340 generates a signal representing the applied polynomial equation R_{NEAD}(m,k).

The threshold estimator processor 350 generates a threshold estimator signal representing the threshold \hat{R}_{NEAD}(m,k) based on the applied polynomial equation R_{NEAD}(m,k). The threshold \hat{R}_{NEAD}(m,k) is used in determining whether an ongoing abnormal noise excursion is present.

The signals generated by the spectral analysis processor 310, the spectral estimator processor 320, the polynomial fitting processor 340 and the threshold estimator processor 350 are delivered to the excursion attenuator processor 360. The excursion attenuator processor 360 comprises an attenuation fitter which is formed by weighting the different frequency components.

The components of the noise attenuation device 305 will now be described in further detail. A block diagram for the signal processing performed by the noise attenuation device 305 is illustrated in FIG. 7.

### Spectral Estimation

The spectral component signal X(m,k) is delivered from the analysis filterbank processor 310 to the spectral estimator processor 320 for processing.

The spectral estimator processor 320 is used to estimate the average power spectrum. The average signal envelope may be estimated with an exponential average as follows

P_{NEAD}(m,k)=10 log₁₀ [α_{NEAD}P_{NEAD}(m−1,k)+(1−α_{NEAD})|X)m,k)|²] (0.18)

where α_{NEAD} is the smoothing factor and |·| denotes the absolute value operator. Typically, the smoothing factor, α_{NEAD} is in the order of few hundred of milliseconds.

However, the average spectrum estimation is not limited to the above method of averaging. The spectral estimator processor 320 thus determines the average power spectrum P_{NEAD}(m,k) and generates an average power spectrum signal.

### Voice Activity Detector

As previously described herein, a voice activity detector (VAD) 330 may optionally be used. The voice activity detector (VAD) 330 may be provided to enhance the precision of the spectral estimation processor 320 if the desired source 301 is a speech source. If a VAD 330 is present, during non speech activity, no update of the average spectrum is undertaken by the spectral estimator processor 320 and thus a shorter averaging time can be used for the spectral estimator processor 320. By way of example, when no VAD 330 is used, the averaging time may be approximately 2-5 seconds. This will allow the spectral estimator to average over voice presence and harmonics in the voice will have no significant influence in the estimate. When a VAD 330 is used, the averaging time may be approximately 0.5 second.

Standard voice activity detection methods can be used to implement the VAD. These standard methods can be modified to fit directly into the internal architecture of the noise attenuator device 305 such that the VAD 330 can operate directly on the spectral components X(m,k).

### Polynomial Fitting

The average power spectrum signal generated by the spectral estimator processor 320 is delivered to the polynomial fitting processor 340.

A polynomial fitting procedure is applied to the average spectral components P_{NEAD}(m,k) represented by the average power spectrum signal. This procedure may be implemented in various ways using known methods. In the following text, the resulting polynomial fitted curve is denoted R_{NEAD}(m,k) regardless of fitting method.

The L-th order polynomial is expressed as

R_{NEAD}(m,k)=c_{L}(m)·k^{L}+ . . . +c₂(m)·k²+c₁(m)·k+c₀(m). (0.19)

where cₗ(m), l=0, . . . , L are coefficients.

The regression line can be sufficiently estimated by using the first order polynomial fit. Thus, the regression line can be rewritten as

R_{NEAD}(m,k)=c₁(m)k+c₀(m) (0.20)

where c₀(m) and c₁(m) are the regression line first order parameters. These parameters can be calculated as

$$[ \begin{matrix}{c}_{0} ( m ) \\ {c}_{1} ( m )\end{matrix} ] = {[ \begin{matrix}{\sum }_{k = 0}^{K - 1} k & {\sum }_{k = 0}^{K - 1} {k}^{2} \\ K & {\sum }_{k = 0}^{K - 1} k\end{matrix} ]}^{- 1} [ \begin{matrix}{\sum }_{k = 0}^{K - 1} k \cdot {P}_{NEAD} ( m , k ) \\ {\sum }_{k = 0}^{K - 1} {P}_{NEAD} ( m , k )\end{matrix} ] . \qquad ( 0.21 )$$

In practice, incorporating first order polynomials has been proven to work effectively for this application and has therefore been used to produce the results presented in the Results section later herein.

The polynomial fitting processor 340 generates a polynomial fitting signal, representing the applied polynomial equation R_{NEAD}(m,k), which is delivered to the threshold estimator 350.

### Threshold Estimation

The threshold estimator 350 estimates a noise threshold \hat{R}_{NEAD}(m,k). To estimate such a threshold, an offset δ_{NEAD} [dB] is added to the polynomial fitted curve equation R_{NEAD}(m,k), as

\hat{R}_{NEAD}(m,k)=R_{NEAD}(m,k)+δ_{NEAD}. (0.22)

The noise threshold \hat{R}_{NEAD}(m,k) may then be used to determine whether or not an ongoing abnormal noise excursion is present in the sound signal x(n).

The threshold estimator processor generates a threshold estimator signal representing the noise threshold \hat{R}_{NEAD}(m,k).

This offset adds an additional measure of safety against misdetections and prevents spectral components, other than truly abnormal excursions, to be attenuated. The offset δ_{NEAD} is empirically determined for each particular noise environment. For the results in the Results section later herein the offset δ_{NEAD} was set to 10 dB. Selecting δ_{KNEAD} to be 10 dB means that perceptually, one sound is about twice as loud as another.

The polynomial equation R_{NEAD}(m,k) gives a linear approximation of the average power spectrum estimate P_{NEAD}(m,k), which means that there will be values that are larger and smaller. The choice of δ_{NEAD} is related to the uncertainty of the power spectrum estimate, i.e., the more uncertainty, the higher δ_{NEAD} value is needed. For instance, the spectral noise excursion coming from rotating machinery that is slowly changing speed will build up and remain at a relatively high level.

### Excursion Attenuator

With high level spectral excursions occurring due to heavy machineries, such as compressors, rotating engines and turbine engines, etc., the disturbing tonal components are typically time, frequency, and amplitude non-stationary.

Hence they are difficult to attenuate using traditional methods, particularly in low and in fast varying SNR conditions.

Attenuation is applied only if the average power spectrum P_{NEAD}(m,k) is larger than the noise threshold \hat{R}_{NEAD}(m,k). Then, the noise attenuation device 305 finds the peak that deviates most from this threshold and attenuates it.

The excursion attenuator processor 360 receives the signals generated by the spectral analysis processor 310, the spectral estimator processor 320, the polynomial fitting processor 340 and the threshold estimator processor 360. The excursion attenuator processor 360 processes the data in those signals to determine the frequency domain output and then generate a frequency domain output signal, as follows.

The difference between the average power spectrum and the threshold is defined as

D_{NEAD}(m,k)=P_{NEAD}(m,k)−\hat{R}_{NEAD}(m,k) (0.23)

and the index to largest peak may be found as

$$ind = {arg max}_{k} ( {D}_{NEAD} ( m , k ) ) .$$

Now, a one tap filter in [dB] can be expressed as

$${\hat{G}}_{NEAD} ( m , k ) = \{ \begin{matrix}( {P}_{NEAD} ( m , k ) - {R}_{NEAD} ( m , k ) ) \cdot {Q}_{1} & if k = ind and {D}_{NEAD} ( m , k ) > 0 \\ ( {P}_{NEAD} ( m , k ) - {R}_{NEAD} ( m , k ) ) \cdot {Q}_{2} & if k = ind \pm 1 and {D}_{NEAD} ( m , k ) > 0 \\ 0 & otherwise\end{matrix}$$

where Q₁ and Q₂ are constants that may be used to enable for varying the attenuation at k=ind and k=ind±1. Typically, these constants are chosen to equal one and

$$\frac{1}{\sqrt{2}} ,$$

respectively.

The actual filter can then be calculated as

$${G}_{NEAD} ( m , k ) = {10}^{\frac{{\hat{G}}_{NEAD} ( m , k )}{20} .} \qquad ( 0.24 )$$

In the current embodiment, the calculated NEAD filter is applied to the received signal in the lower path 11 via 9 as shown in FIG. 2. In a separate embodiment, the calculated NEAD filter can be readily applied to the received signal and synthesised into fullband domain via 370 as shown in FIG. 7.

The noise attenuation device 305 can find multiple peaks in an iterative manner using the method hereinbefore described. If a first peak is found, an adjacent spectral region is protected. The peak finding procedure is then repeated on remaining spectral components and hence multiple noise excursions can be attenuated.

To take into account varying frequency and also not affect the overall speech characteristics, adjacent frequency bands are attenuated less. Speech intelligibility and masking effects are hence considered as important in this design.

The noise attenuation device 305 seeks to mainly attenuate only one frequency band and not apply attenuation to more than three adjacent frequency bands simultaneously. However, this needs to be commensurate with masking effects. It is also possible to use perceptual masking to further enhance the performance of the present invention at a higher computational complexity.

### Results

In practice, when using some form of first order polynomial fitting, the parameters (e.g. averaging time and threshold) can be set to detect only narrowband disturbing noise excursions and leave other spectral content (e.g. speech) unaffected.

Also, if a frequency and amplitude varying high level noise component is within the speech frequency band, it will be very annoying and strongly mask the speech that is present. By attenuating only a narrow frequency part of the received signal, the unwanted noise will be removed and the speech will remain natural sounding.

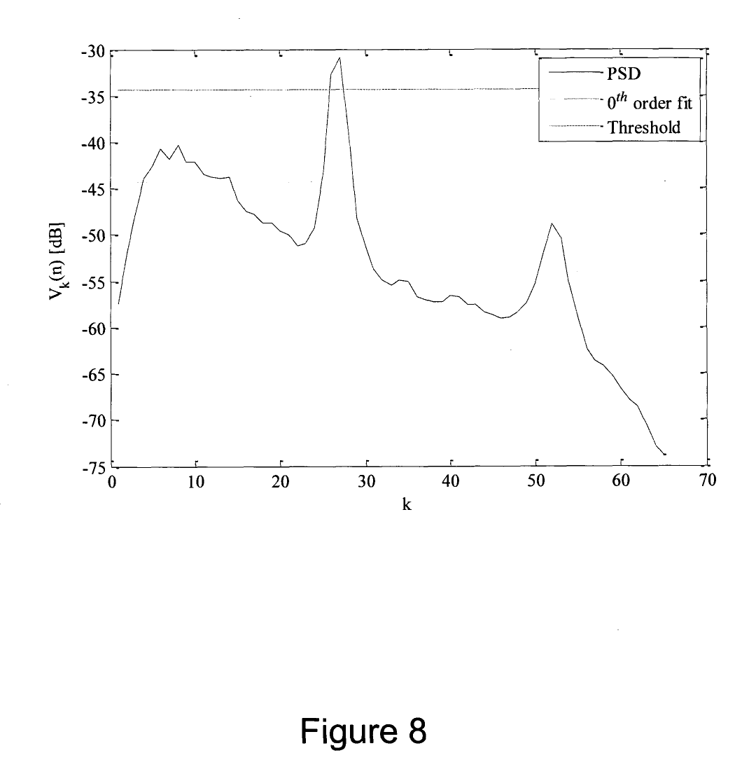

In FIG. 8, the attenuation of unwanted noise excursions can be seen when a linear regression (first order polynomial) was incorporated in the polynomial fitting method.

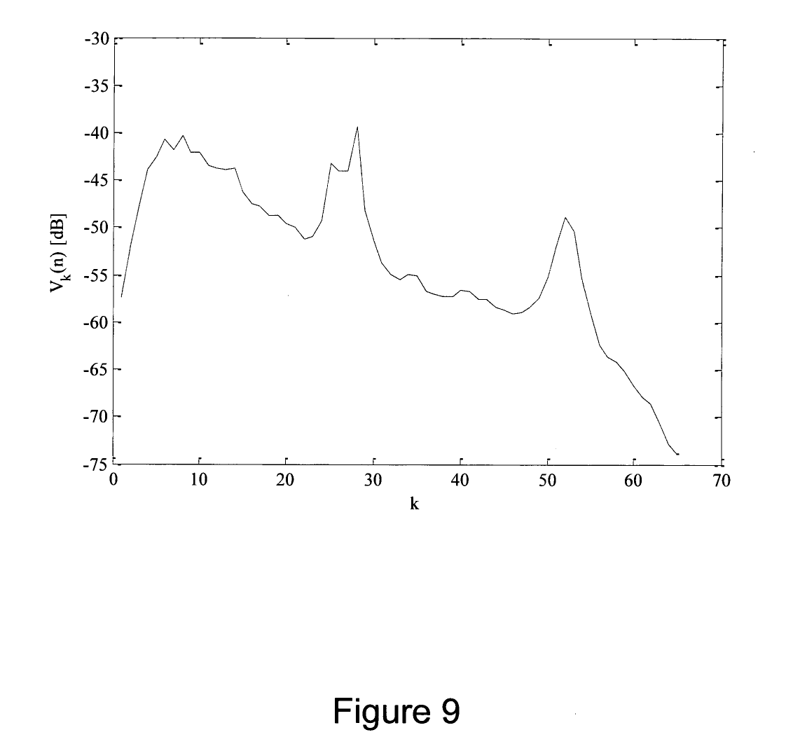

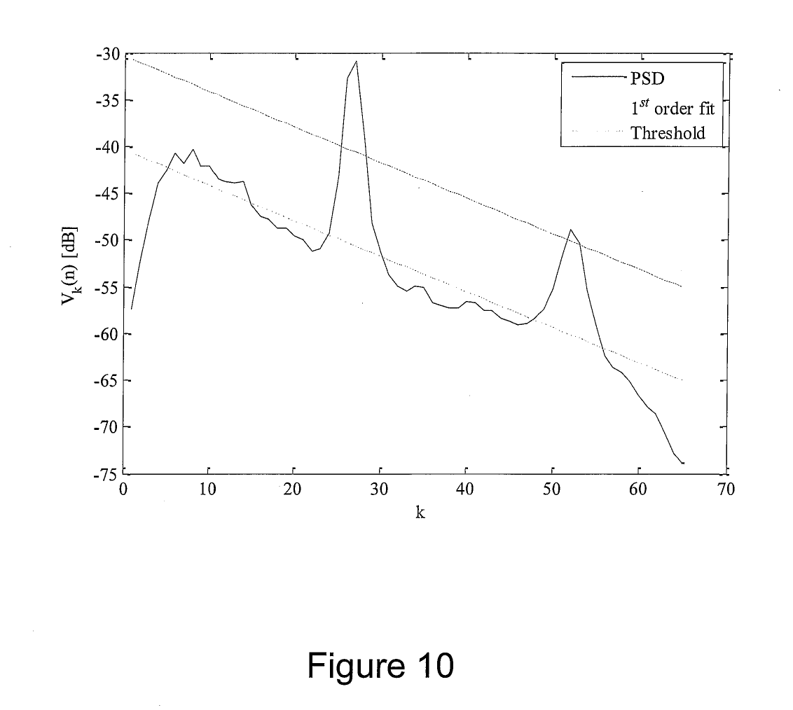

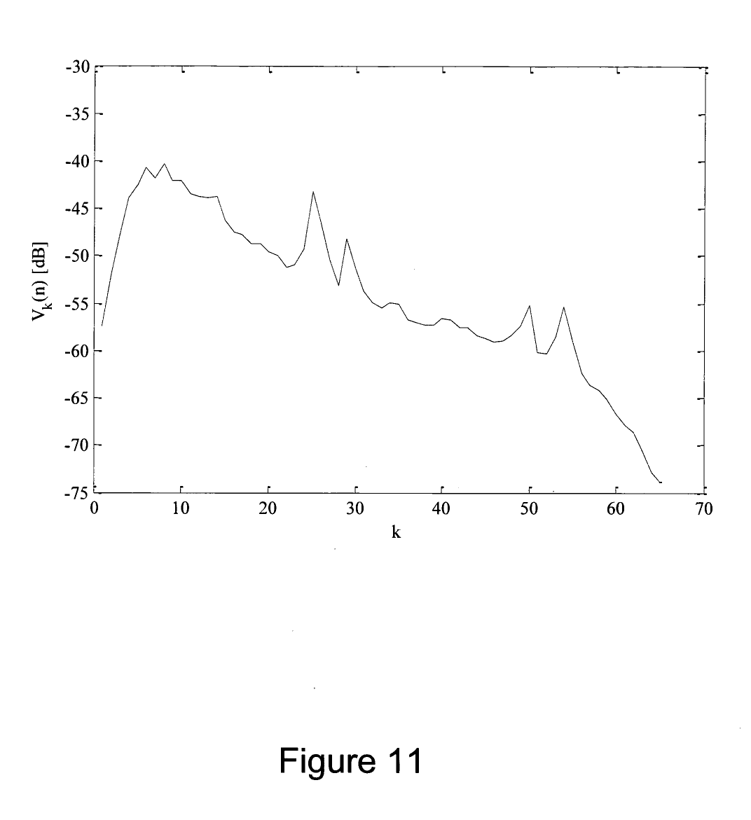

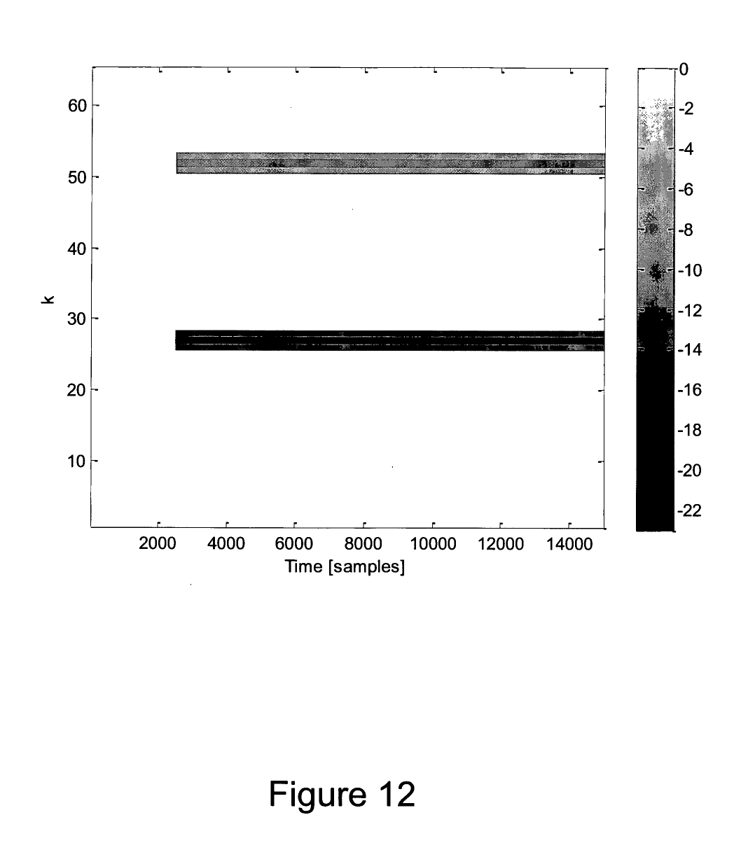

The results for data obtained from one typical measurement from an industrial setting, which included compressor noise, are shown in FIG. 8, FIG. 9, FIG. 10, FIG. 11, and FIG. 12.

In FIG. 8 (before NEAD) and FIG. 9 (after NEAD), a zero order polynomial is used in the curve fitting procedure.

In FIG. 10 (before NEAD) and FIG. 11 (after NEAD), a first order polynomial is used.

FIG. 12 shows the filter, Ĝ_{NEAD}(m,k) in dB, over time (spectrogram) when the curve fitting is based on a first order polynomial. It can be seen that the unwanted peaks are successfully suppressed while other frequency regions remain unaffected.

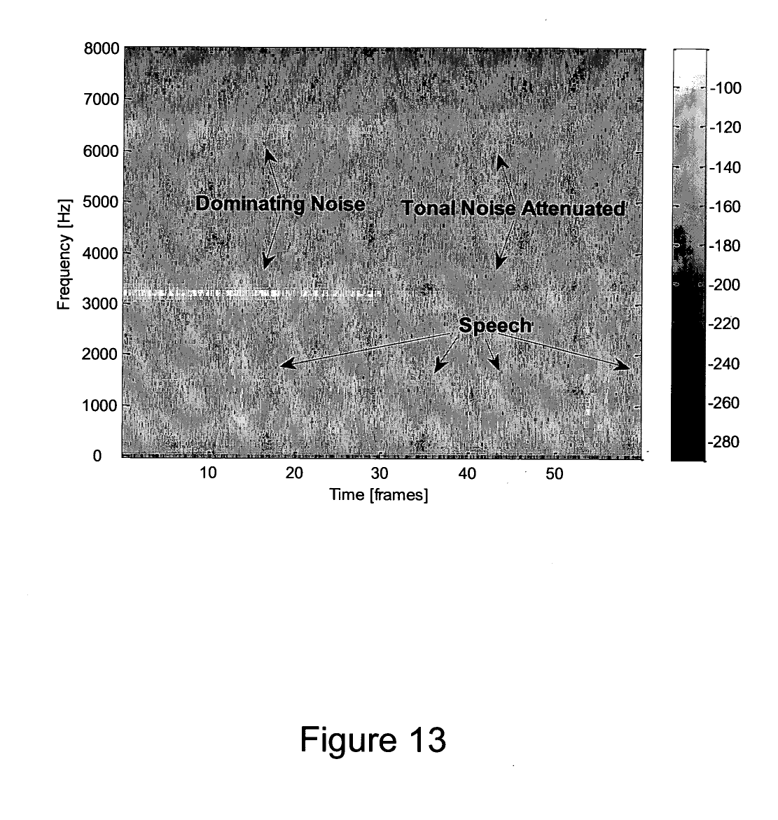

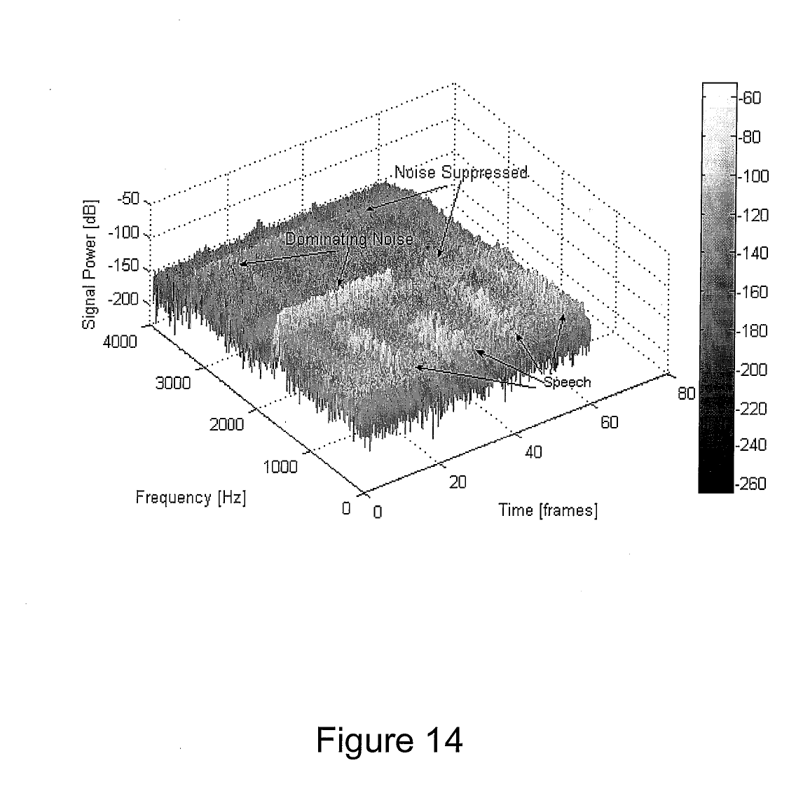

FIG. 13 and FIG. 14 each show the effects both before and after the noise attenuation of the present invention is implemented.

The noise attenuation device 305 provides an apparatus and method for suppressing spectral excursions in high noise environments. The noise attenuation device 305 works efficiently in speech disturbance and industrial noise environments. It allows suppression of, for example, compressors and other equipment that has tonal components that are varying in frequency and amplitude, i.e. noise excursions. The noise attenuation device 305 may also be used for suppression of stable tonal components in noisy environments. However, the ability of the noise attenuation device 305 to also suppress tonal components that vary in frequency and amplitude extends the capabilities of the noise attenuation device 305 into a more general environment in contrast to conventional methods.

The noise attenuation device 305 is robust against spectral variations in the background noise excursion. This avoids suppressing vital parts in speech that need to be retained and thereby improves speech intelligibility with no added extra artefacts.

The method and device of the noise attenuation device 305 can be used independently or in an environment with other spatial, temporal or spectral methods for noise attenuation. The noise attenuation device 305 has properties that allow it to be combined with spectral subtraction and Wiener filter methods as well as array technology methods.

Modifications and variations such as would be apparent to a skilled address are deemed to be within the scope of the present invention.

1. A signal processing device comprising
a signal analyser for transforming a received signal into the subband domain;
a first signal path and a second signal path, the first signal path being decoupled from the second signal path, whereby the first signal path and the second signal path are arranged to pass the received signal;
only the first signal path includes automatic gain control, the first signal path further includes one or more signal processing means to determine filters therein, the signal in the first signal path being passed from the automatic gain control to the one or more signal processing means to enable determination of filters, the filters determined by the one or more signal processing means being combined to generate one or more overall filters which are applied to the signal in the second signal path to generate a processed signal; and a signal synthesiser for synthesising the processed signal into a fullband representation.

2. A signal processing device according to claim 1, wherein the filters are determined on the basis of ratios.

3. A signal processing device according to claim 1, wherein the one or more signal processing means comprise one or more signal processing algorithms.

4. A signal processing device according to claim 3, wherein the signal processing algorithms are implemented in fixed point.

5. A signal processing device according to claim 1, wherein the first signal path has a numerical precision representation that is different from the numerical precision representation of the second signal path.

6. A signal processing device according to claim 5, wherein the first signal path has a numerical precision representation that is lower than the numerical precision representation of the second signal path.

7. A signal processing device according to claim 1, wherein the signal processing device is optimised for digital fixed point signal processing tasks.

8-14. (canceled)

15. A method for processing signals comprising
transforming a received signal into the subband domain; passing the received signal into a first signal path and a second signal path, the first signal path being decoupled from the second signal path; applying automatic gain control to the signal in the first signal path only; determining filters in one or more signal processing means in the first signal path, combining the filters to generate one or more overall filters which are applied to the signal in the second signal path to generate a processed signal; and
synthesising the processed signal into a fullband representation.

16. A method for processing signals according to claim 15, wherein determining filters comprises determining filters on the basis of ratios.

17. A method for processing signals according to claim 15, further comprising providing the one or more signal processing means as one or more signal processing algorithms.

18. A method for processing signals according to claim 17, further comprising implementing the signal processing algorithms in fixed point.

19. A method for processing signals according to claim 15, further comprising providing the first signal path with a numerical precision representation that is different from the numerical precision representation of the second signal path.

20. A method for processing signals according to claim 19, further comprising providing the first signal path with a numerical precision representation that is lower than the numerical precision representation of the second signal path.

21. A method for processing signals according to claim 15, further comprising optimising the signal processing for digital fixed point signal processing tasks.

22. A hearing protection device comprising a signal processing device comprising
a signal analyser for transforming a received signal into the subband domain;
a first signal path and a second signal path, the first signal path being decoupled from the second signal path, whereby the first signal path and second signal path are arranged to pass the received signal;
only the first signal path includes automatic gain control, the first signal path further includes one or more signal processing means to determine filters therein, the signal in the first signal path being passed from the automatic gain control to the one or more signal processing means to enable determination of the filters, the filters determined by the one or more signal processing means being combined to generate one or more overall filters which are applied to the signal in the second signal path to generate a processed signal; and a signal synthesiser for synthesising the processed signal into a fullband representation.

23. A hearing protection device according to claim 22, wherein the filters are determined on the basis of ratios.

24. A hearing protection device according to claim 23, wherein the one or more signal processing means comprise one or more signal processing algorithms.

25. A hearing protection device according to claim 24, wherein the signal processing algorithms are implemented in fixed point.

26. A hearing protection device according to claim 22, wherein the first signal path has a numerical precision representation that is different from the numerical precision representation of the second signal path.

27. A hearing protection device according to claim 26, wherein the first signal path has a numerical precision representation that is lower than the numerical precision representation of the second signal path.

28. A hearing protection device according to claim 22, wherein the signal processor is optimised for digital fixed point signal processing tasks.

29. A hearing protection device according to claim 22, further comprising at least one ear muff or plug and wherein at least one of the components of the voice communication device is located in said at least one ear muff or plug.
